(19) United States
(12) Patent Application Publication
(10) Pub. No.: US 2015/0049761 A1
(43) Pub. Date: Feb. 19, 2015

(54) Network Relay System and Switching Device

(71) Applicant: Hitachi Metals, Ltd., Tokyo (JP)

(72) Inventors: Wataru KUMAGAI, Ichikawa (JP); Tomoyoshi TATSUMI, Tsuchiura (JP)

(21) Appl. No.: 14/329,625

(22) Filed: Jul. 11, 2014

(30) Foreign Application Priority Data
Aug. 19, 2013 (JP) 2013-169820

(51) Int. Cl. H04L 12/18

(52) U.S. Cl. CPC H04L 12/1836
USPC 370/390

(57) ABSTRACT

When a first switching device receives a control frame such as IGMP report at a MLAG port, it learns a multicast (MC) group contained in the control frame in association with the MLAG port on a MC address table. Also, the first switching device generates a bridge control frame containing the control frame and an identifier of the MLAG port and transfers it from a bridge port. On the other hand, when the second switching device receives the bridge control frame at the bridge port, it detects the control frame and the identifier of the MLAG port from the bridge control frame and learns the MC group contained in the control frame in association with its own MLAG port on the MC address table.

### CROSS-REFERENCE TO RELATED APPLICATION

The present application claims priority from Japanese Patent Application No. 2013-169820 filed on Aug. 19, 2013, the content of which is hereby incorporated by reference into this application.

### TECHNICAL FIELD OF THE INVENTION

The present invention relates to a network relay system and a switching device, for example, a network relay system in which a link aggregation is set across two switching devices and each switching device is provided with a multicast snooping function.

### BACKGROUND OF THE INVENTION

For example, Japanese Patent Application Laid-Open Publication No. 2008-78893 (Patent Document 1) discloses a configuration including a pair of medium switching devices connected to each other by redundant ports and a lower switching device and an upper switching device connected in a state where link aggregations are set to the ports having the same port numbers of the pair of medium switching devices. Also, Japanese Patent Application Laid-Open Publication No. 2009-232400 (Patent Document 2) discloses a method of bandwidth control of a link aggregation group in a communication system in which the link aggregation group is set across communication devices.

### SUMMARY OF THE INVENTION

As a redundant system, for example, a system in which two ports in one switching device [A] and each one port in two switching devices [B] are respectively connected by communication lines has been known as disclosed in the Patent Document 1 or the Patent Document 2. At this time, the one switching device [A] sets a link aggregation to its own two ports. Also, the two switching devices [B] have communication through a dedicated communication line, thereby allowing each one port thereof to function as logically (virtually) one port when viewed from the one switching device [A].

In this redundant system, unlike a common link aggregation set physically to one switching device, a link aggregation is set physically across two switching devices [B]. Therefore, in addition to general effects obtained by the link aggregation such as the redundancy for the fault of communication lines and the expansion of communication band, the redundancy for the fault of switching devices can be achieved. In this specification, the link aggregation across two switching devices [B] as described above is referred to as a multi-chassis link aggregation (hereinafter, abbreviated as MLAG). Also, the assembly of the two switching devices [B] is referred to as a multi-chassis link aggregation device (hereinafter, abbreviated as MLAG device).

On the other hand, as a multicast communication protocol, a routing protocol typified by PIM (Protocol Independent Multicast) or the like and a protocol for managing the members of a multicast group typified by IGMP (Internet Group Management Protocol), MLD (Multicast Listener Discovery) or the like have been known. For example, terminals wishing to join in a multicast group issue a join request to a predetermined multicast group by using IGMP or MLD to a layer 3 (hereinafter, abbreviated as L3) switching device executing a L3 process through a layer 2 (hereinafter, abbreviated as L2) switching device executing a L2 process. The L3 switching device which has received the join request establishes a delivery route of a multicast packet to a server device serving as a source of the multicast packet by using PIM or the like on the L3 network.

In this manner, the multicast packet from the server device is delivered to the terminal through the L3 network and the L2 switching device. However, at this time, since the L2 switching device which has received the multicast packet (multicast frame) usually does not learn the multicast MAC (Media Access Control) address, it delivers the received multicast packet (multicast frame) by flooding. In this case, since the multicast frame is delivered also to the terminals which are not the members of the predetermined multicast group, the communication band is wastefully consumed. Thus, techniques called IGMP snooping and MLD snooping have been known.

In the case where the IGMP snooping or the MLD snooping is used, when the L2 switching device receives a join request or the like to a multicast group from a terminal, it learns information of the multicast group contained in the join request or the like in association with the port which has received the join request or the like on a multicast address table. As a result, the L2 switching device can deliver the multicast frame only to the port where the terminal to be a member of the multicast group is present by retrieving the multicast address table when the L2 switching device receives the multicast packet (multicast frame) from the server device.

In such a circumstance, the inventors of the present invention have studied the application of the MLAG device to the L2 switching device provided with the multicast snooping function (for example, IGMP snooping or MLD snooping). In this case, a mechanism for sharing (synchronizing) the multicast address table between the two switching devices constituting the MLAG device is required in general. As the sharing (synchronizing) mechanism, for example, the system in which update information or the like of the multicast address table is properly transmitted and received between the two switching devices is conceivable.

Since complicated process is necessary for the learning process for the multicast address table in general, the software process by CPU (Central Processing Unit) is used in many cases. In this case, one switching device constituting the MLAG device updates its own multicast address table by using its own CPU and then transfers the update information to the other switching device, and the other switching device updates its own multicast address table by using its own CPU based on the update information.

However, in the case where the multicast address table is shared (synchronized) by using the system described above, there is a possibility that it takes a certain period of time from when the multicast address table is updated in the one switching device to when the multicast address table reflecting the update information is formed in the other switching device. For example, when the multicast packet (multicast frame) is received in this time lag period, such a case may occur in which the destination differs depending on which of the two switching devices constituting the MLAG device has received the multicast frame. As a result, it becomes difficult to correctly achieve the multicast snooping function as the MLAG device.

The present invention has been made in view of the problem mentioned above, and one object of the present invention is to easily achieve the multicast snooping function in a network relay system including two switching devices to which the MLAG is set.

The above and other objects and novel characteristics of the present invention will be apparent from the description of the present specification and the accompanying drawings.

The following is a brief description of an outline of the typical embodiment of the invention disclosed in the present application.

A network relay system of the embodiment includes first and second switching devices each having a plurality of MLAG ports, a bridge port and a multicast address table and connected to each other by a bridge communication line through the bridge ports. Each of the first and second switching devices sets a link aggregation group between its own MLAG port and a MLAG port of the other switching device corresponding to the MLAG port. Here, when one of the first and second switching devices receives a control frame representing a join request to or a leave request from a predetermined multicast group at any one of the plurality of MLAG ports, it executes a first process and a second process. In the first process, it learns the predetermined multicast group contained in the control frame in association with a MLAG port which has received the control frame on the multicast address table. In the second process, it generates a bridge control frame containing the control frame and an identifier of the MLAG port which has received the control frame and transferring the bridge control frame from the bridge port. Also, when the other of the first and second switching devices receives the bridge control frame at the bridge port, it executes a third process and a fourth process. In the third process, it detects the control frame and the identifier of the MLAG port from the bridge control frame. In the fourth process, it learns the predetermined multicast group contained in the control frame in association with its own MLAG port corresponding to the identifier of the MLAG port on the multicast address table.

The effects obtained by typical embodiments of the invention disclosed in the present application will be briefly described below. That is, it is possible to easily achieve the multicast snooping function in the two switching devices to which the MLAG is set.

### BRIEF DESCRIPTIONS OF THE DRAWINGS

FIG. 1 is a block diagram showing a schematic configuration example and an operation example of a network system serving as an application example of a network relay system according to the first embodiment of the present invention;

FIG. 2 is a block diagram showing a schematic configuration example of the network relay system according to the first embodiment of the present invention;

FIG. 3 is an explanatory diagram showing an operation example of a main part of the network relay system of FIG. 2;

FIG. 4A is a schematic diagram showing a configuration example of a control frame in FIG. 3;

FIG. 4B is a schematic diagram showing a configuration example of a bridge control frame in FIG. 3;

FIG. 5 is an explanatory diagram showing an operation example of a main part of a network relay system according to the second embodiment of the present invention;

FIG. 6 is a schematic diagram showing a configuration example of a multicast user frame in FIG. 5;

FIG. 7 is an explanatory diagram showing an operation example of a main part of a network relay system different from that of FIG. 5 according to the second embodiment of the present invention;

FIG. 8 is a block diagram showing a schematic configuration example of a main part of a switching device according to the third embodiment of the present invention;

FIG. 9A is a diagram showing a configuration example of a MLAG table in FIG. 8;

FIG. 9B is a diagram showing a configuration example of a unicast address table in FIG. 8;

FIG. 9C is a diagram showing a configuration example of a multicast address table in FIG. 8;

FIG. 10 is a flowchart showing an example of a main process of the frame processing unit in FIG. 8;

FIG. 11 is a flowchart showing an example of a part of the process in FIG. 10 in detail;

FIG. 12 is a flowchart showing an example of a part of the process in FIG. 10 in detail;

FIG. 13A is an explanatory diagram showing a different operation example studied as a comparative example of FIG. 5 and FIG. 7; and

FIG. 13B is an explanatory diagram showing a different operation example studied as a comparative example of FIG. 5 and FIG. 7.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or apart of the other as a modification example, details, or a supplementary explanation thereof. Also, in the embodiments described below, when referring to the number of elements (including number of pieces, values, amount, range, and the like), the number of the elements is not limited to a specific number unless otherwise stated or except the case where the number is apparently limited to a specific number in principle, and the number larger or smaller than the specified number is also applicable.

Further, in the embodiments described below, it goes without saying that the components (including element steps) are not always indispensable unless otherwise stated or except the case where the components are apparently indispensable in principle. Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Hereinafter, embodiments of the present invention will be described in detail with reference to the accompanying drawings. Note that components having the same function are denoted by the same reference symbols throughout the drawings for describing the embodiments, and the repetitive description thereof will be omitted.

### First Embodiment

### Outline of Network System

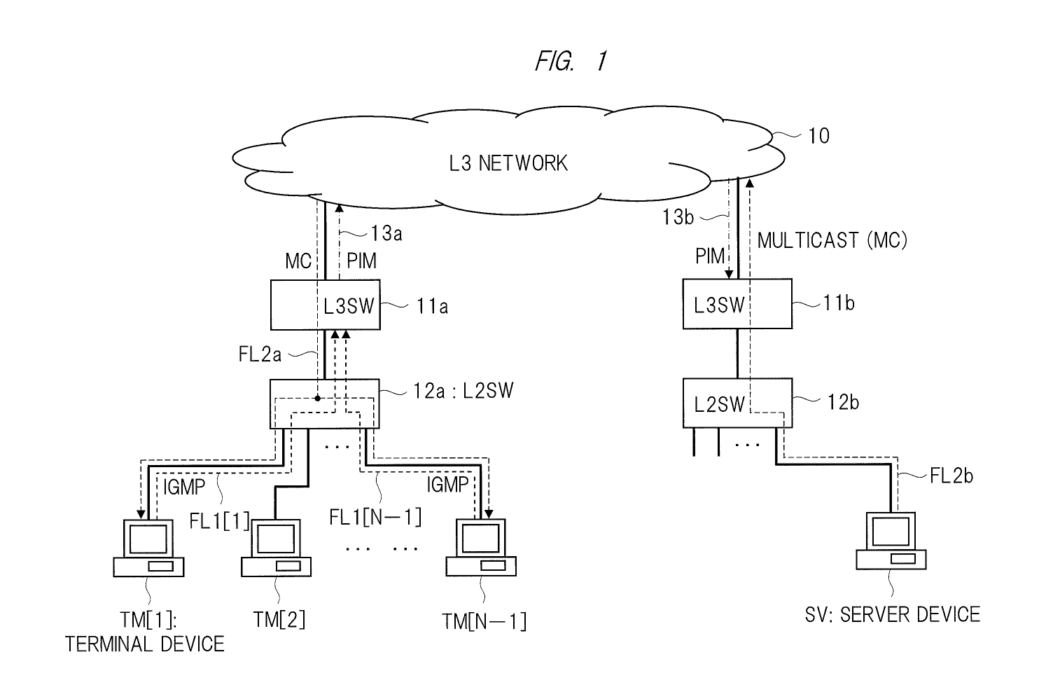

FIG. 1 is a block diagram showing a schematic configuration example and an operation example of a network system serving as an application example of a network relay system according to the first embodiment of the present invention. The network system shown in FIG. 1 includes a L3 network 10, a plurality of L3 switching devices (L3SW) 11a and 11b, a plurality of L2 switching devices (L2SW) 12a and 12b, a plurality of (here, (N−1)) terminal devices TM[1] to TM[N−1], and a server device SV. The L3 switching devices (L3SW) 11a and 11b are connected to the L3 network 10. The L2 switching device (L2SW) 12a is connected to the plurality of terminal devices TM[1] to TM[N−1] and the L3 switching device (L3SW) 11a. The L2 switching device (L2SW) 12b is connected to the server device SV and the L3 switching device (L3SW) 11b.

The server device SV is a source of a multicast packet, and the plurality of terminal devices TM[1] to TM[N−1] are destinations of the multicast packet. Here, as an example, one server device SV is connected to the L2 switching device (L2SW) 12b, but one or plural terminal devices may be connected in addition to the server device SV or a plurality of server devices may be connected thereto. Similarly, the plurality of terminal devices TM[1] to TM[N−1] are connected to the L2 switching device (L2SW) 12a, but one or plural server devices may be connected thereto in addition to the terminal devices.

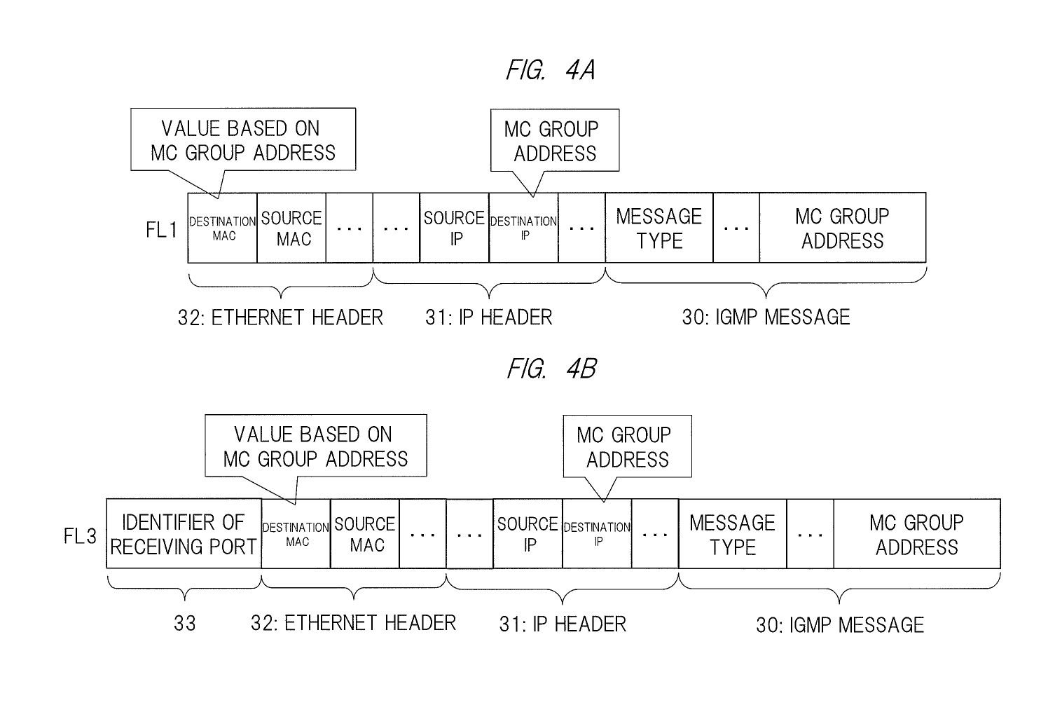

Here, the operation will be briefly described based on an example in which the terminal devices TM[1] and TM[N−1] join in a multicast group whose source is the server device SV. The terminal device TM[1] transmits a control frame FL1[1] representing a join request to a multicast group typified by, for example, an IGMP report to the L3 switching device (L3SW) 11a through the L2 switching device (L2SW) 12a. Similarly, the terminal device TM[N−1] also transmits a control frame FL1[N−1] representing a join request to a multicast group to the L3 switching device (L3SW) 11a through the L2 switching device (L2SW) 12a. Although details will be described later with reference to FIG. 4A, the control frames FL1[1] and FL1[N−1] contain the information of the multicast group in which the terminals wish to join, and the information of the multicast group whose source is the server device SV is contained in this case.

The L3 switching device (L3SW) 11a recognizes that the terminal device wishing to join in a multicast group whose source is the server device SV is present under itself upon receipt of the control frames FL1[1] and FL1[N−1] from the terminal devices TM[1] and TM [N−1]. Then, the L3 switching device (L3SW) 11a establishes a delivery route of a multicast packet between itself and the L3 switching device (L3SW) 11b to which the server device SV belongs through the L3 network 10 by using a multicast routing protocol typified by PIM.

More specifically, for example, the L3 switching device (L3SW) 11a transmits a PIM join 13a to a predetermined L3 switching device (L3SW) in the L3 network 10. Though not shown, the L3 network 10 includes a plurality of L3 switching devices (L3SW). The L3 switching device (L3SW) which has received the PIM join 13a similarly transmits the PIM join to the predetermined L3 switching device (L3SW) in the L3 network 10. Thereafter, the PIM join is transmitted hop by hop to the predetermined L3 switching device (L3SW) in the L3 network 10 in the same manner, and finally transmitted as a PIM join 13b to the L3 switching device (L3SW) 11b.

The delivery route of the multicast packet is determined by the route through which the PIM join is transmitted. The multicast packet (multicast user frame) FL2b delivered from the server device SV is received at the L3 switching device (L3SW) 11b through the L2 switching device (L2SW) 12b and is further received at the L3 switching device (L3SW) 11a through the above-described delivery route of the multicast packet. Then, the L3 switching device (L3SW) 11a delivers the multicast packet (multicast user frame) FL2a to the terminal devices TM[1] and TM[N−1] through the L2 switching device (L2SW) 12a.

Note that the operation example in which IGMP is used as the join request to a predetermined multicast group has been shown here, but the same is true of the case using MLD or the like. Also, the operation example in which PIM-SM (Sparse Mode), PIM-SSM (Source Specific Multicast) or the like is used as the multicast routing protocol has been shown here, but PIM-DM (Dense Mode) or the like may of course be used.

In such a configuration example and an operation example, the network relay system of the first embodiment is applied to a part of the L2 switching device (L2SW) 12a. Since a lot of terminal devices TM[1] to TM[N−1] are sometimes connected to the L2 switching device (L2SW) 12a as the destinations of the multicast packet, it is desired to sufficiently secure the fault tolerance and the communication band. In such a case, it is beneficial to apply the MLAG device as the L2 switching device (L2SW) 12a and further to provide the multicast snooping function for the MLAG device.

<<Configuration of Network Relay System>>

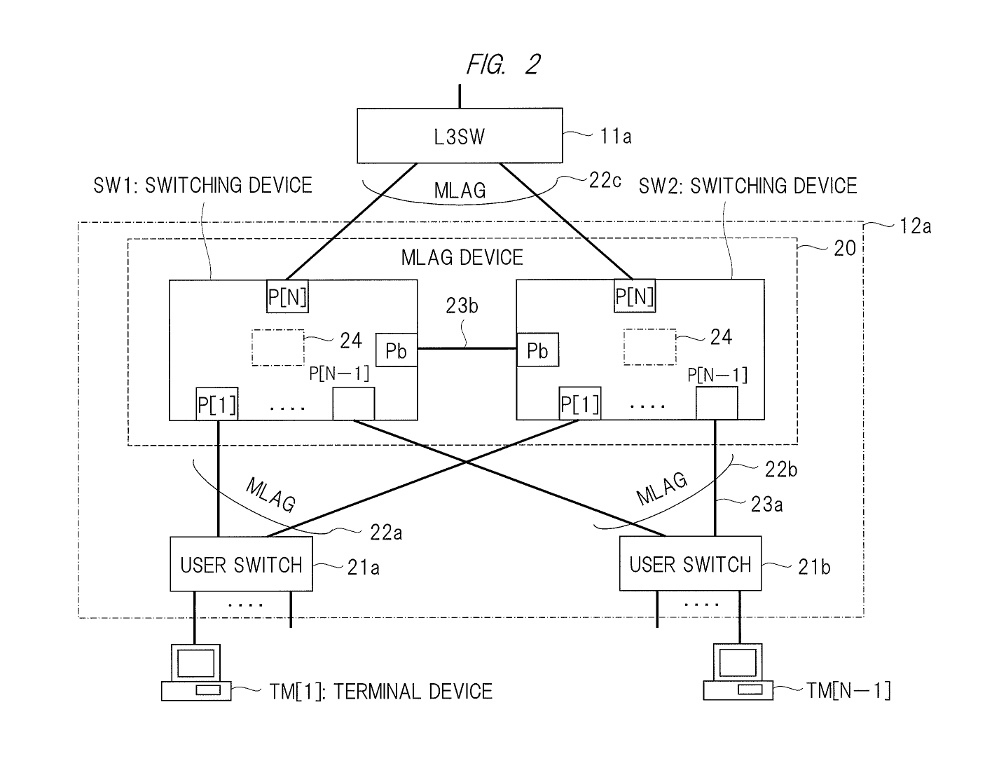

FIG. 2 is a block diagram showing a schematic configuration example of the network relay system according to the first embodiment of the present invention. The network relay system shown in FIG. 2 is applied to, for example, the part of the L2 switching device (L2SW) 12a of FIG. 1, and includes a MLAG device 20 composed of first and second switching devices SW1 and SW2 and a plurality of user switches 21a and 21b. Each of the first and second switching devices SW1 and SW2 has a plurality of (here, N (N is an integer of 2 or more)) MLAG ports P[1] to P[N], a bridge port Pb, and a multicast address table 24, and the first and second switching devices SW1 and SW2 are connected to each other via the bridge ports Pb by a bridge communication line 23b.

The user switch 21a is connected to the MLAG port P[1] of the first switching device SW1 and the MLAG port P[1] of the second switching device SW2 through communication lines 23a. The user switch 21a sets the link aggregation group (MLAG 22a) to the ports serving as connection sources of the communication lines 23a. The user switch 21b is connected to the MLAG port P[N−1] of the first switching device SW1 and the MLAG port P[N−1] of the second switching device SW2 through communication lines 23a. The user switch 21b sets the link aggregation group (MLAG 22b) to the ports serving as connection sources of the communication lines 23a. In this example, the terminal device TM[1] is connected to the user switch 21a, and the terminal device TM[N−1] is connected to the user switch 21b.

FIG. 2 shows also the L3 switching device (L3SW) 11a of FIG. 1. The L3 switching device (L3SW) 11a is connected to the MLAG port P[N] of the first switching device SW1 and the MLAG port P[N] of the second switching device SW2 through the communication lines 23a. The L3 switching device (L3SW) 11a sets the link aggregation group (MLAG 22c) to the ports serving as connection sources of the communication lines 23a.

Each of the first and second switching devices SW1 and SW2 sets the link aggregation group (that is, MLAG) between its own MLAG port and the MLAG port of the other switching device corresponding to that MLAG port. For example, each of the first and second switching devices SW1 and SW2 sets MLAG 22a between its own (for example, SW1) MLAG port P[1] and the MLAG port P[1] of the other switching device (for example, SW2). Similarly, each of the first and second switching devices SW1 and SW2 sets MLAG 22b to the MLAG ports P[N−1] of both switching devices, and sets MLAG 22c to the MLAG ports P[N] of both switching devices. In the first and second switching devices SW1 and SW2, the MLAG ports of both switching devices to which the MLAG is set logically (virtually) function as one port.

<<Operation of Main Part of Network Relay System>>

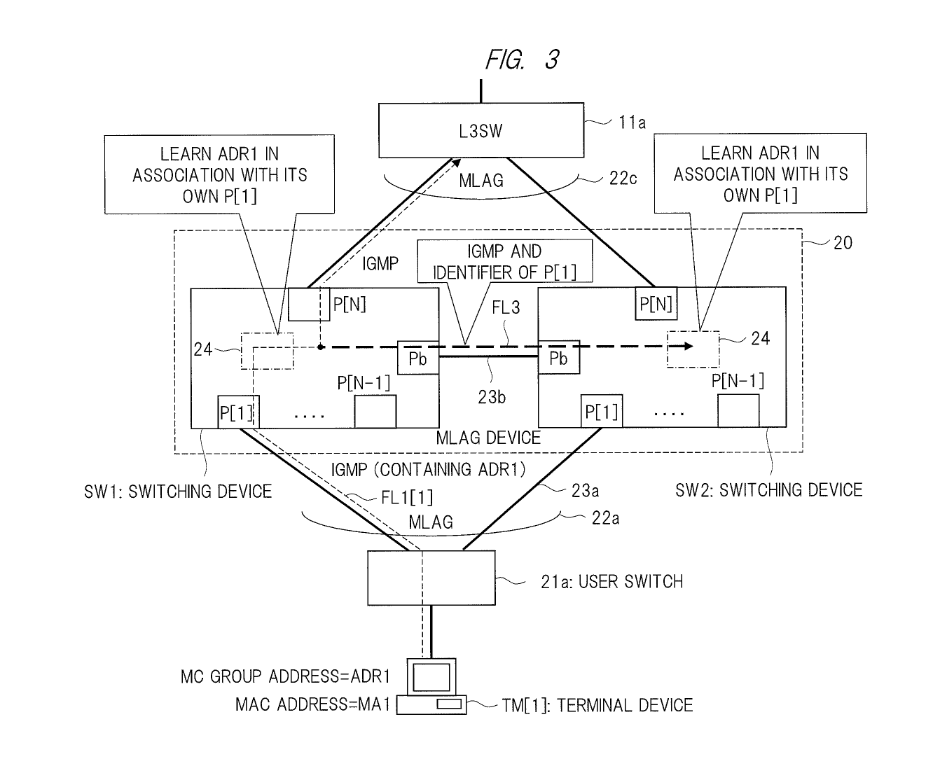

FIG. 3 is an explanatory diagram showing an operation example of a main part of the network relay system of FIG. 2. In FIG. 3, the illustration of the user switch 21b is omitted with respect to FIG. 2 as a matter of convenience. Also, in FIG. 3, the MAC address of the terminal device TM[1] is “MA1” and the multicast group address in which the terminal device TM[1] wishes to join is “ADR1”. In the following description, the multicast may be sometimes abbreviated as “MC”.

One of the first and second switching devices SW1 and SW2 executes a learning process (first process) for the multicast address table 24 when it receives a control frame representing a join request to or a leave request from a predetermined multicast group at any one of the plurality of MLAG ports. Then, during the learning process, one of the first and second switching devices SW1 and SW2 learns the predetermined multicast group contained in the control frame in association with the MLAG port which has received the control frame on the multicast address table 24. In other words, the multicast snooping process is executed.

In the example of FIG. 3, the first switching device SW1 executes the learning process for the multicast address table 24 when it receives the control frame (for example, IGMP report) FL1[1] representing the join request to the MC group address “ADR1” at the MLAG port P[1]. Then, during the learning process, the first switching device SW1 learns the MC group address “ADR1” contained in the control frame FL1[1] in association with its own MLAG port P[1] which has received the control frame FL1[1] on the multicast address table 24.

Also, when one of the first and second switching devices SW1 and SW2 receives the above-mentioned control frame at any one of the plurality of MLAG ports, it generates a bridge control frame containing the control frame and an identifier of the MLAG port which has received the control frame and transfers it from the bridge port Pb (second process). In the example of FIG. 3, when the first switching device SW1 receives the control frame FL1[1] at the MLAG port P[1], it generates a bridge control frame FL3 containing the control frame (IGMP report) and an identifier of the MLAG port P[1] and transfers it from the bridge port Pb. Note that the first switching device SW1 executes also the process of transferring the control frame (IGMP report) FL1[1] from a MLAG port (for example, P[N]) other than the port which has received the control frame.

When the other of the first and second switching devices SW1 and SW2 receives the bridge control frame at the bridge port Pb, it detects the control frame and the identifier of the MLAG port from the bridge control frame (third process). In the example of FIG. 3, when the second switching device SW2 receives the bridge control frame FL3 at the bridge port Pb, it detects the control frame (IGMP report) FL1[1] and the identifier of the MLAG port P[1] from the bridge control frame FL3.

Also, based on the control frame and the identifier of the MLAG port detected in the third process, the other of the first and second switching devices SW1 and SW2 learns the predetermined multicast group contained in the control frame in association with its own MLAG port corresponding to the identifier of the MLAG port on the multicast address table 24 (fourth process). In the example of FIG. 3, based on the control frame FL1[1] and the identifier of the MLAG port P[1] detected in the third process, the second switching devices SW2 learns the MC group address “ADR1” contained in the control frame (IGMP report) FL[1] in association with its own MLAG port P[1] on the multicast address table 24. In other words, the multicast snooping process is executed.

By using the configuration example and the operation example described above, the high-speed synchronization of the multicast address table 24 can be easily achieved between the switching devices SW1 and SW2 constituting the MLAG device 20. As a result, the multicast snooping function as the MLAG device 20 can also be easily achieved.

More specifically, firstly, when the first switching device SW1 receives the control frame FL1[1], it can generate and transfer the bridge control frame FL3 in parallel with the update of the multicast address table 24 without waiting for the completion of the update of the multicast address table 24. At this time, since the generation and transfer of the bridge control frame FL3 (that is, second process mentioned above) are a simple process, they can be executed by a dedicated hardware circuit (for example, FPGA (Field Programmable Gate Array) or the like) instead of software process using CPU.

On the other hand, the second switching device SW2 detects the control frame FL1[1] and the identifier of the MLAG port after receiving the bridge control frame FL3. Since this detection of the control frame FL1[1] and the identifier of the MLAG port (that is, third process mentioned above) is also a simple process, it can be executed by a dedicated hardware circuit. In this manner, the time lag between when the first switching device SW1 starts the update of its own multicast address table 24 and when the second switching device SW2 starts the update of its own multicast address table 24 based on the same information can be sufficiently shortened.

FIG. 4A is a schematic diagram showing a configuration example of the control frame in FIG. 3 and FIG. 4B is a schematic diagram showing a configuration example of the bridge control frame in FIG. 3. The control frame FL1 shown in FIG. 4A typically represents the configuration example of the control frames FL1[1] and FL1[N−1] shown in FIG. 1 and FIG. 3. The control frame FL1 has a configuration based on IGMP, and includes an IGMP message portion 30, an IP (Internet Protocol) header portion 31, and an Ethernet (registered trademark) header portion 32. The IGMP message portion 30 contains a MC group address and a message type. In the message type, for example, a code representing a join request to a multicast group or a code representing a leave request from a multicast group is stored. The multicast group at this time is determined by the MC group address.

The IP header portion 31 contains a destination IP address and a source IP address. As the destination IP address, for example, the same value as the MC group address in the IGMP message portion 30 is stored. The Ethernet header portion 32 contains a source MAC address and a destination MAC address. As the destination MAC address, for example, a value obtained by adding “0” of 1 bit and a fixed value (01_{—}00_{—}5Eh) of 24 bits to a part (lower 23 bits) of the MC group address in the IGMP message portion 30 is stored.

For example, in the case of the control frame FL1[1] of FIG. 3, “ADR1” is stored in the MC group address in the IGMP message portion 30, and the code representing the join request is stored in the message type. In the IP header portion 31, “ADR1” is stored in the destination IP address, and the IP address of the terminal device TM[1] is stored in the source IP address. In the Ethernet header portion 32, “MA1” is stored in the source MAC address, and a predetermined value based on “ADR1” is stored in the destination MAC address as described above. Therefore, in the multicast snooping process described with reference to FIG. 3 (that is, first process and fourth process), though not particularly limited, the destination MAC address contained in the control frame FL1 of FIG. 4A is learned in association with the predetermined MLAG port (P[1] in FIG. 3).

The bridge control frame FL3 shown in FIG. 4B has the configuration obtained by adding an identifier 33 of a receiving port (MLAG port) to the control frame FL1 shown in FIG. 4A. As the identifier 33 of the receiving port, in the example of FIG. 3, the identifier of the MLAG port P[1] is stored.

As described above, by using the network relay system and the switching device of the first embodiment, typically, the multicast snooping function as the MLAG device can be easily achieved.

### Second Embodiment

### Operation of Main Part of Network Relay System

### Application Example [1]

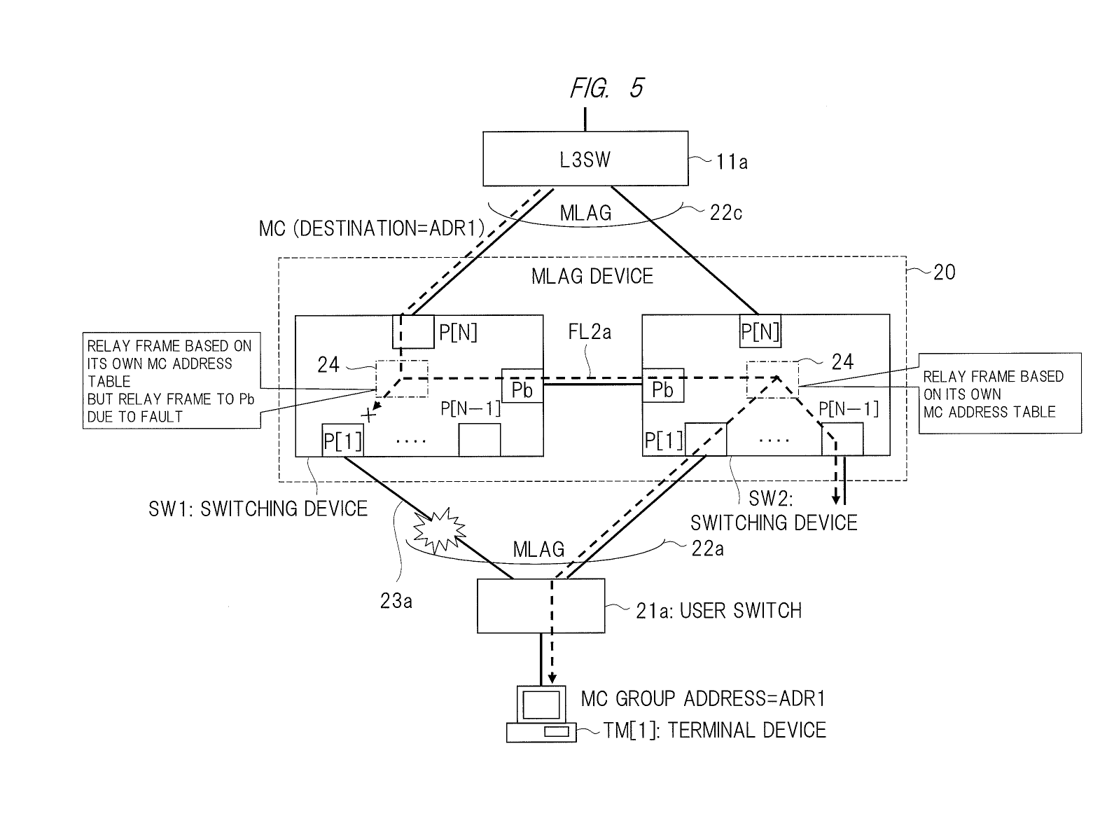

FIG. 5 is an explanatory diagram showing an operation example of a main part of a network relay system according to the second embodiment of the present invention. FIG. 5 shows an operation example in the case where the MLAG device 20 receives the multicast packet (multicast user frame) FL2a from the L3 switching device (L3SW) 11a based on the configuration example and the operation example of FIG. 3 described above. Furthermore, FIG. 5 shows also an operation example in the case where a fault occurs in a link between the switching device SW1 and the user switch 21a. The link means an assembly of the communication line 23a and ports at both ends thereof.

When one of the first and second switching devices SW1 and SW2 receives the multicast user frame at any one of the plurality of MLAG ports, it retrieves a destination MLAG port from among the plurality of MLAG ports based on the multicast address table 24 (fifth process). In the example of FIG. 5, when the first switching device SW1 receives the multicast user frame FL2a at the MLAG port P[N], it retrieves a destination MLAG port based on the multicast address table 24. In this example, the retrieved destination MLAG ports are MLAG ports P[1] and P[N−1] in conformity with FIG. 1.

Also, when the destination MLAG port retrieved in the fifth process has a fault, one of the first and second switching devices SW1 and SW2 transfers the received multicast user frame from the bridge port Pb (sixth process). In the example of FIG. 5, since the destination MLAG port P[1] has a fault, the first switching device SW1 directly transfers the received multicast user frame FL2a from the bridge port Pb.

When the other of the first and second switching devices SW1 and SW2 receives the multicast user frame at the bridge port Pb, it retrieves the destination MLAG port from among the plurality of MLAG ports based on its own multicast address table 24 (seventh process). In the example of FIG. 5, when the second switching device SW2 receives the multicast user frame FL2a at the bridge port Pb, it retrieves a destination MLAG port based on its own multicast address table 24. In this example, the retrieved destination MLAG ports are MLAG ports P[1] and P[N−1].

Also, the other of the first and second switching devices SW1 and SW2 transfers the multicast user frame received at the bridge port Pb from the destination MLAG port retrieved in the seventh process. In the example of FIG. 5, the second switching device SW2 transfers the multicast user frame FL2a received at the bridge port Pb from the destination MLAG ports P[1] and P[N−1] retrieved in the seventh process.

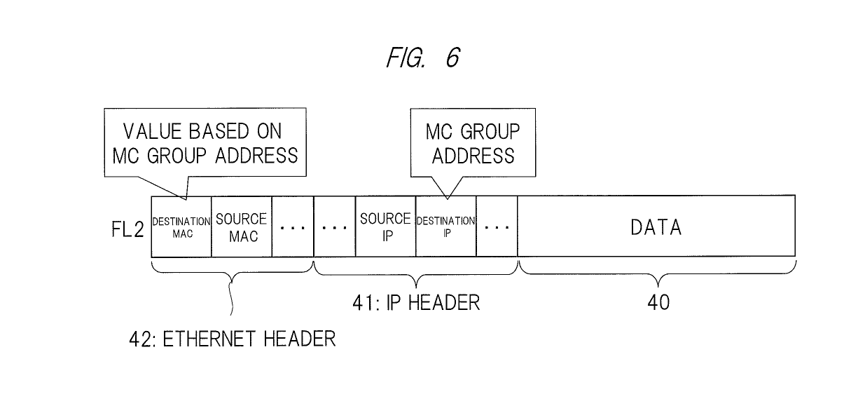

FIG. 6 is a schematic diagram showing a configuration example of the multicast user frame in FIG. 5. The multicast user frame FL2 shown in FIG. 6 typically represents the configuration example of the multicast user frames FL2a and FL2b shown in FIG. 1 and FIG. 5. The multicast user frame FL2 includes a data portion 40, an IP header portion 41, and an Ethernet header portion 42. In the data portion 40, a predetermined delivery data is stored. The IP header portion 41 contains a destination IP address and a source IP address. In the destination IP address, for example, a MC group address is stored. The Ethernet header portion 42 contains a source MAC address and a destination MAC address. In the destination MAC address, like the case of FIG. 4A, for example, a value obtained by adding a predetermined value to a part of the MC group address is stored.

For example, in the case of the multicast user frame FL2a of FIG. 5, in the IP header portion 41, “ADR1” is set to the destination IP address, and the IP address of the server device SV of FIG. 1 is set to the source IP address. In the Ethernet header portion 42, the MAC address of the L3 switching device (L3SW) 11a of FIG. 5 is set to the source MAC address, and the predetermined value based on “ADR1” is set to the destination MAC address as described above.

### Operation of Main Part of Network Relay System

### Application Example [2]

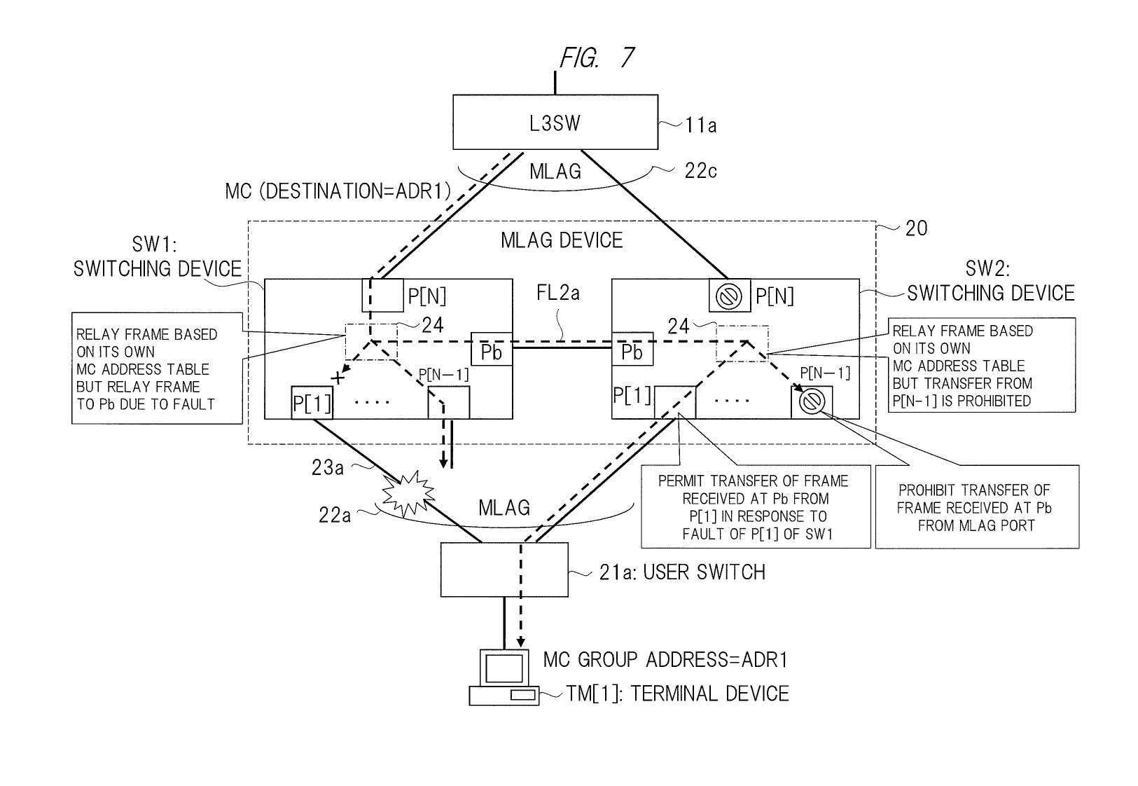

FIG. 7 is an explanatory diagram showing an operation example of a main part of a network relay system different from that of FIG. 5 according to the second embodiment of the present invention. Compared with the operation example of FIG. 5, the operation example of FIG. 7 differs in that the transfer of the multicast user frame FL2a from the MLAG port P[N−1] is performed on the switching device SW1 side instead of the switching device SW2 side.

In this case, each of the first and second switching devices SW1 and SW2 is preliminarily configured so that the transfer of the frame received at the bridge port Pb from the MLAG ports is prohibited (for example, P[N−1] and P[N] of SW2 of FIG. 7). However, each of the first and second switching devices SW1 and SW2 is preliminarily configured so that, when one switching device receives information indicating that a MLAG port has a fault from the other switching device through the bridge port Pb, the transfer of the frame received at the bridge port Pb from its own MLAG port corresponding to the MLAG port having a fault is permitted (for example, P[1] of SW2 of FIG. 7).

Under such a premise, the first switching device SW1 retrieves the destination MLAG port of the multicast user frame FL2a received at the MLAG port P[N] in the same manner as the case of FIG. 5 (fifth process). In this example, the retrieved destination MLAG ports are MLAG ports P[1] and P[N−1]. Also, since the destination MLAG port P[1] of the first switching device SW1 has a fault like the case of FIG. 5, the first switching device SW1 transfers the received multicast user frame FL2a from the bridge port Pb (sixth process). In addition, the first switching device SW1 transfers the multicast user frame FL2a also from the MLAG port P[N−1] having no fault among the destination MLAG ports.

On the other hand, when the second switching device SW2 receives the multicast user frame FL2a at the bridge port Pb, it retrieves the destination MLAG port in the same manner as the case of FIG. 5 (seventh process). In this case, the retrieved destination MLAG ports are the MLAG ports P[1] and P[N−1]. Next, the second switching device SW2 transfers the multicast user frame FL2a from the destination MLAG port. In this case, however, based on the configuration described above, the transfer from the MLAG port P[N−1] is prohibited and the transfer from MLAG port P[1] is permitted in advance. As a result, the second switching device SW2 transfers the multicast user frame FL2a only from the MLAG port P[1].

### Operation of Main Part of Network Relay System

### Comparative Example

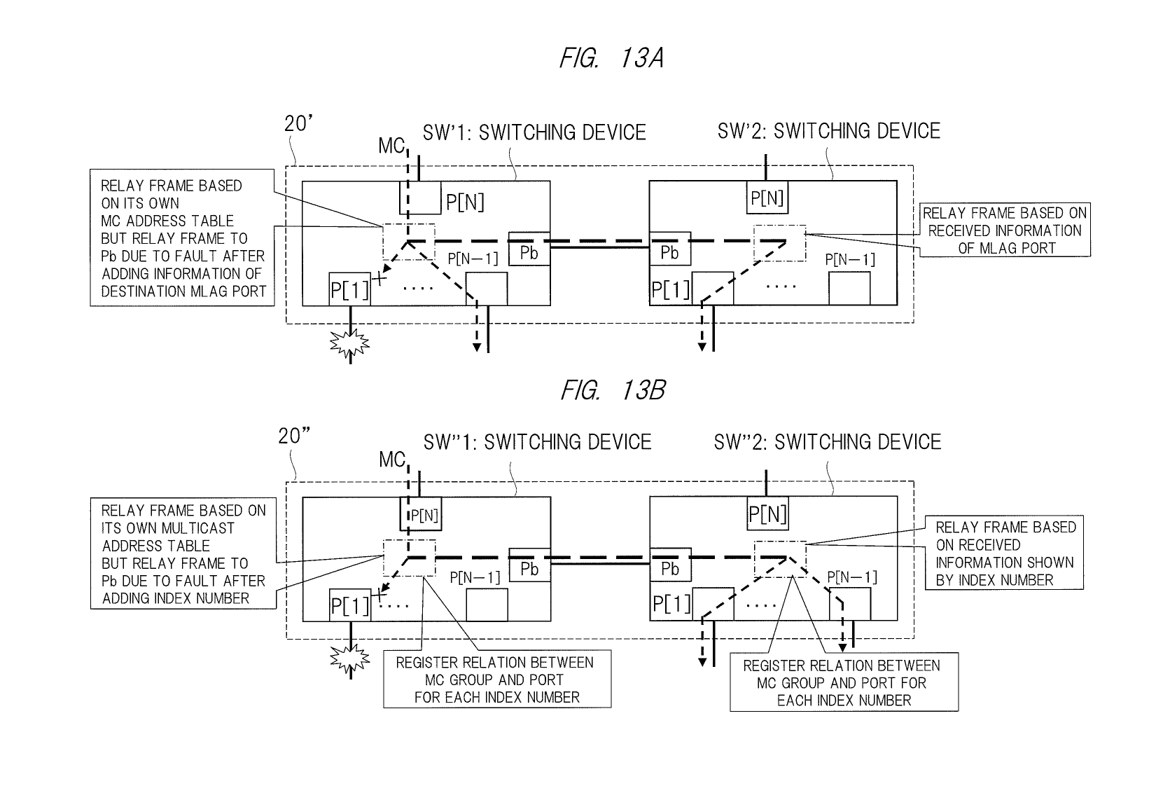

FIG. 13A and FIG. 13B are explanatory diagrams showing different operation examples studied as comparative examples of FIG. 5 and FIG. 7. For example, as shown in FIG. 13A, the method in which the first switching device SW′1 which has received the MC user frame determines all of the destination MLAG ports and the other second switching device SW′2 does not retrieve the MC address table in the MLAG device 20′ is conceivable.

Specifically, firstly, when the first switching device SW′1 receives the MC user frame at the MLAG port P[N], it determines the destination MLAG ports (here, P[1] and P[N−1]) by retrieving its own MC address table. Next, the first switching device SW′1 transfers the MC user frame from the destination MLAG port P[N−1] and transfers it also from the bridge port Pb after adding information of the destination MLAG port P[1] to the header of the MC user frame because the destination MLAG port P[1] has a fault. When the second switching device SW′2 receives the MC user frame to which information of the destination MLAG port P[1] is added at the bridge port Pb, it transfers the MC user frame from the MLAG port P[1] based on the added information.

However, when the method like this is used, for example, if there are a plurality of destination MLAG ports having a fault on the first switching device SW′1 side, there is a possibility that the amount of information added to the header is increased and the communication band between the bridge ports Pb becomes insufficient. Thus, for example, as shown in FIG. 13B, based on the premise that the MC address tables of the first and second switching devices SW″1 and SW″2 are always synchronized in the MLAG device 20″, the method in which the relation between the MC group and the MLAG port on the MC address table is managed by index numbers is conceivable.

Specifically, firstly, when the first switching device SW″1 receives the MC user frame at the MLAG port P[N], it determines the destination MLAG ports (here, P[1] and P[N−1]) by retrieving each index number of its own MC address table. However, since the destination MLAG port P[1] has a fault, the first switching device SW″1 adds a corresponding index number to the header of the MC user frame and then transfers the frame from the bridge port Pb. When the second switching device SW″2 receives the MC user frame to which the index number is added at the bridge port Pb, it transfers the MC user frame from the MLAG ports P[1] and P[N−1] based on the information described at the index number in its own MC address table. In this case, since the header information added to the MC user frame is only the index number, the amount of information can be reduced.

However, when the method like this is used, the MC address tables in the first and second switching devices SW″1 and SW″2 need to be always synchronized including the order of the index numbers. In this index method, for example, each of the first and second switching devices SW″1 and SW″2 updates the MC address table while sequentially changing the index numbers every time when it receives a new IGMP report. At this time, by updating the MC address table by using the same method as that of the above-described first embodiment, the time lag at the time when the first and second switching devices SW″1 and SW″2 update the MC address table can be sufficiently reduced, but it is not easy to completely eliminate the time lag. In this index method, since there is a possibility that the MC user frame is delivered to a completely different destination when the index numbers are mismatched, the above-mentioned time lag needs to be reduced as close to zero as possible in order to prevent the mismatch of the index numbers, but this is not actually easy to achieve.

On the other hand, in the method of the second embodiment, when the destination MLAG port has a fault, one switching device transfers the received MC user frame to the other switching device without particularly adding header information, and the other switching device determines the destination MLAG port based on its own multicast address table. In this manner, it is possible to avoid the above-described case in which the communication band between the bridge ports Pb becomes insufficient. At this time, as described in the first embodiment, since the MC address tables are synchronized at high speed, the case in which the destination MLAG ports differ between the both switching devices can be sufficiently avoided. Also, since the no time lag is not always required unlike the above-described index method, no practical problem occurs if the MC address tables are synchronized at sufficiently high speed. Consequently, the multicast snooping function as the MLAG device can be easily achieved.

### Third Embodiment

### Configuration of Switching Device

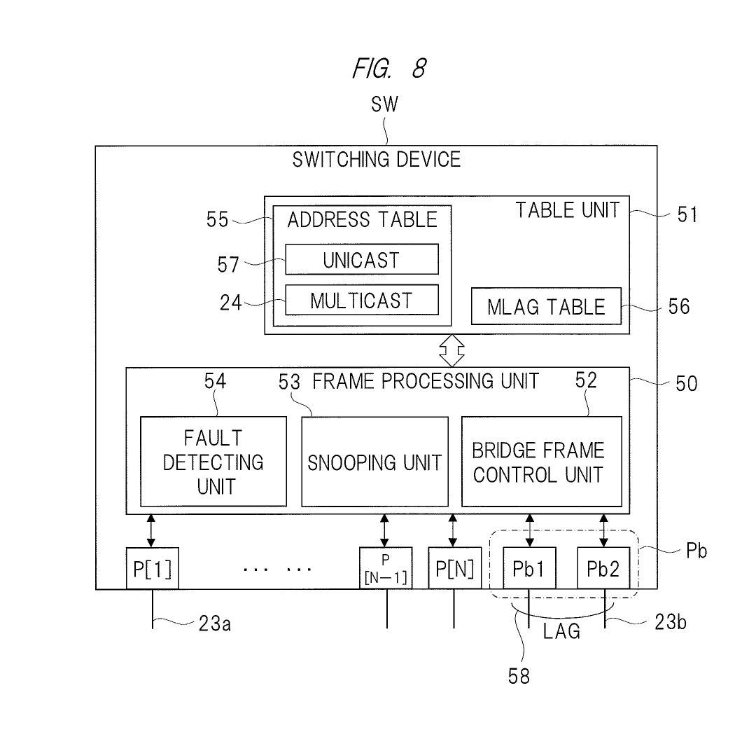

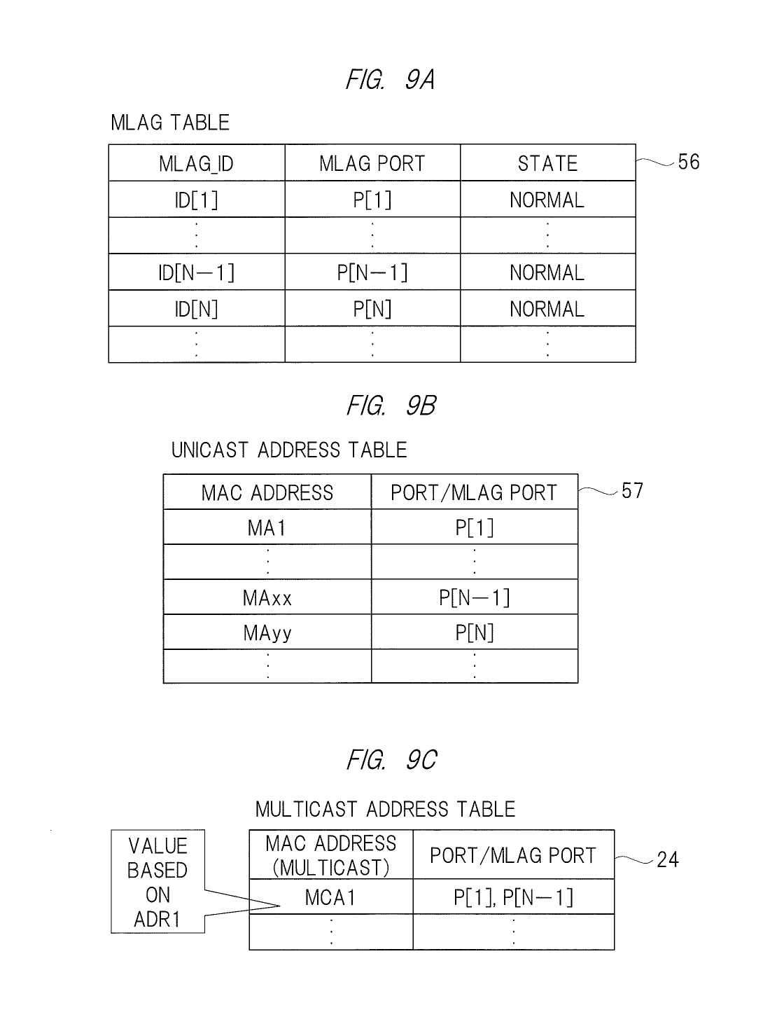

FIG. 8 is a block diagram showing a schematic configuration example of a main part of a switching device according to the third embodiment of the present invention. FIG. 9A is a diagram showing a configuration example of a MLAG table in FIG. 8, FIG. 9B is a diagram showing a configuration example of a unicast address table in FIG. 8, and FIG. 9C is a diagram showing a configuration example of a multicast address table in FIG. 8. The switching device SW shown in FIG. 8 typically represents the configuration example of the first and second switching devices SW1 and SW2 shown in FIG. 2. For example, this switching device SW includes a frame processing unit 50, a table unit 51, a plurality of ports (MLAG ports P[1] to P[N] and bridge ports Pb1 and Pb2) and others.

When taking FIG. 2 as an example, user switches 21a and 21b are properly connected to the MLAG ports P[1] to P[N−1] through the communication lines 23a. The L3 switching device (L3SW) 11a is connected to the MLAG port P[N] through the communication line 23a. Other switching devices are connected to the bridge ports Pb1 and Pb2 through bridge communication lines 23b. In this example, the bridge port Pb of FIG. 2 is composed of a plurality of (here, two) bridge ports Pb1 and Pb2 in order to sufficiently secure the fault tolerance and the communication band. The switching device SW sets the link aggregation group (LAG) 58 to the bridge ports Pb1 and Pb2.

The table unit 51 includes an address table 55 and a MLAG table 56. The address table 55 further includes a unicast address table 57 and a multicast address table 24. As shown in FIG. 9A, for example, the MLAG table 56 retains an identifier of MLAG (MLAG_ID), a MLAG port corresponding thereto, and information about the presence of fault in the port. In this example, the MLAG_ID of ID[1] is set to the MLAG port P[1], and this port does not have any fault (normal). As the identifier 33 of the receiving port described with reference to FIG. 4, for example, this MLAG_ID is stored.

As shown in FIG. 9B, the unicast address table 57 retains a relation between a port/LAG port and a MAC address present ahead of the port/MLAG port. In this example, the terminal device TM[1] having the MAC address “MA1” is present ahead of the MLAG port P[1] as shown in FIG. 3. Note that the MLAG device 20 of FIG. 2 and others has the MLAG port and may have also a port to which MLAG is not set, and the unicast address table 57 retains also a relation between such a port and a MAC address present ahead of it.

As shown in FIG. 9C, the multicast address table 24 retains a relation between a multicast MAC address and one or plural port/MLAG port at which a terminal device having the MAC address is present. In this example, a terminal device having a multicast MAC address “MCA1” is present ahead of MLAG ports P[1] and P[N−1]. The MAC address “MCA1” is a value based on the MC group address (for example, “ADR1” in the terminal address TM[1] of FIG. 3) as described with reference to FIG. 4A and others.

The frame processing unit 50 includes a bridge frame control unit 52, a snooping unit 53, and a fault detecting unit 54, and mainly controls the relay of the frame between each MLAG ports P[1] to P[N] and the relay of the frame through the bridge ports Pb1 and Pb2 based on the information of the table unit 51. The bridge frame control unit 52 is composed of, for example, a dedicated hardware circuit (FPGA or others) and executes various processes regarding the bridge control frame FL3 described with reference to FIG. 3. The snooping unit 53 executes the learning process and the retrieving process for the multicast address table 24 described with reference to FIG. 3, FIG. 5 and FIG. 7. Although not particularly limited, the fault detecting unit 54 monitors the presence of fault at each of the MLAG ports P[1] to P[N] by transmitting and receiving a presence recognition management frame at the MLAG ports P[1] to P[N]. Also, the fault detecting unit 54 reflects the monitoring result on the MLAG table 56 shown in FIG. 9A.

<<Operation of Switching Device>>

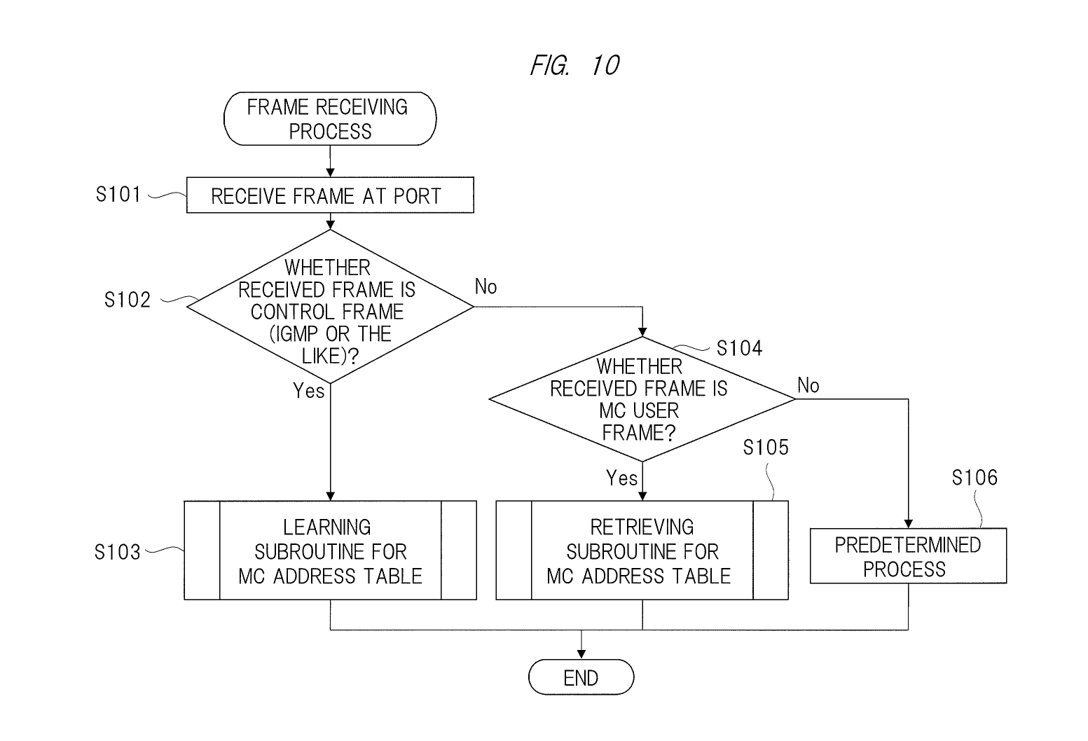

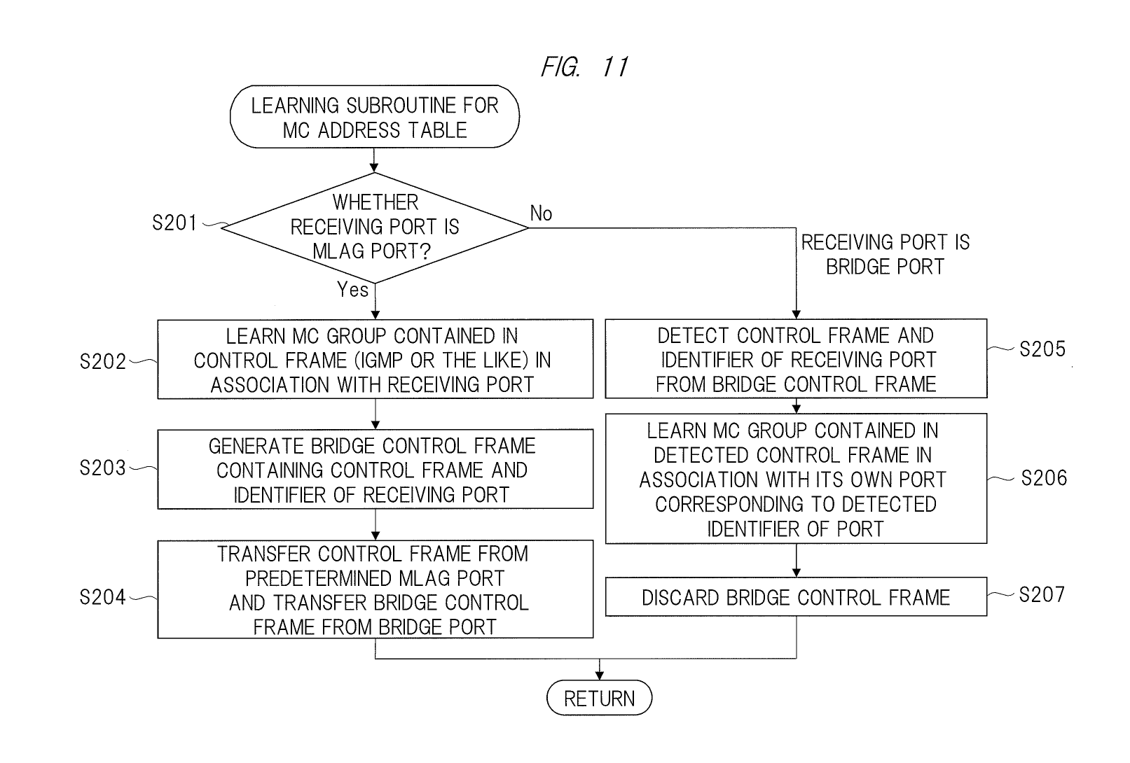

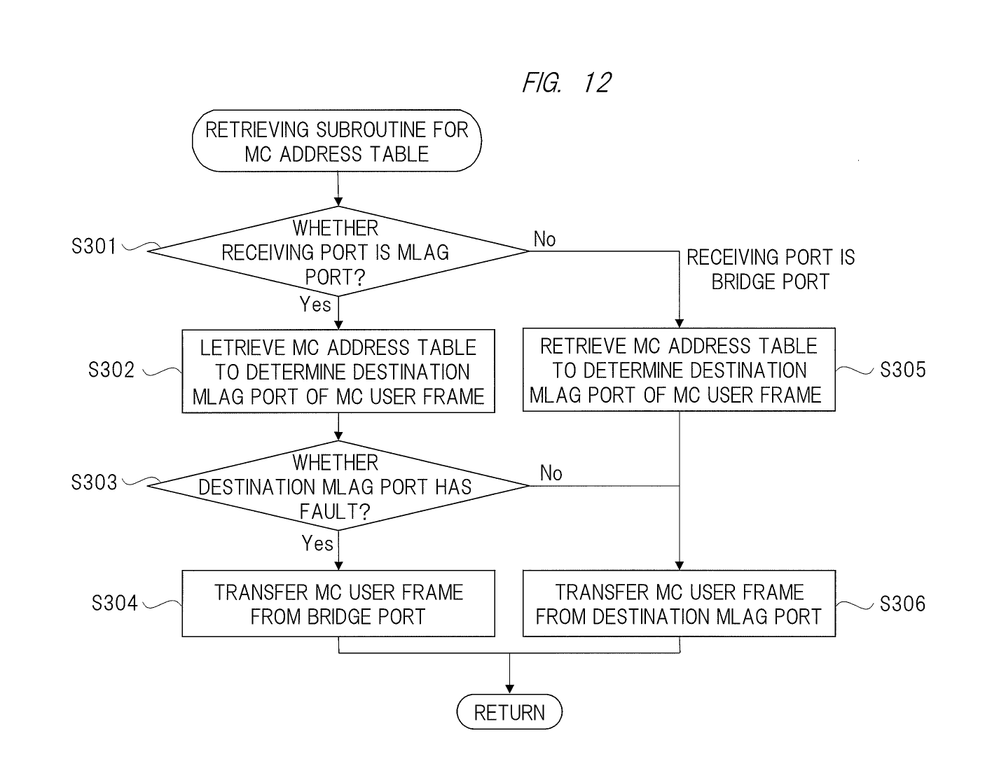

FIG. 10 is a flowchart showing an example of a main process of the frame processing unit in FIG. 8. Each of FIG. 11 and FIG. 12 is a flowchart showing an example of a part of the process in FIG. 10 in detail. Here, the process will be described based on the operation of FIG. 3 and FIG. 5 described above. As shown in FIG. 10, the frame processing unit 50 first receives a frame at a port as a frame receiving process (step S101). Next, the frame processing unit 50 determines whether or not the received frame is a control frame (for example, IGMP report) (step S102). This determination is made by the confirmation of the contents of the IGMP message of FIG. 4A by the snooping unit 53.

When the received frame is the control frame, the frame processing unit 50 executes the learning subroutine for the MC address table, and ends the frame receiving process (step S103). On the other hand, when the received frame is not the control frame, the frame processing unit 50 determines whether or not the received frame is the MC user frame (step S104). This determination can be made based on, for example, the destination MAC address and the destination IP address in FIG. 6 and the confirmation result of the snooping unit 53.

When the frame received in the step S104 is the MC user frame, the frame processing unit 50 executes the retrieving subroutine for the MC address table, and ends the frame receiving process (step S105). On the other hands, when the received frame is not the MC user frame, the frame processing unit 50 executes a predetermined process to end the frame receiving process (step S106). In the step S106, for example, the general relay process for the unicast user frame and others are executed.

In the learning subroutine for the MC address table in the step S103, the process shown in FIG. 11 is executed. In FIG. 11, the frame processing unit 50 first determines whether or not the receiving port is the MLAG port (step S201). When it is the MLAG port, the frame processing unit 50 (specifically, snooping unit 53) learns the MC group contained in the control frame (IGMP report or the like) in association with the receiving port (MLAG port) on the MC address table 24.

Next, the frame processing unit 50 (specifically, bridge frame control unit 52) generates the bridge control frame (for example, FL3 of FIG. 3) containing the control frame and the identifier of the port (MLAG port) which has received the control frame (step S203). Subsequently, the frame processing unit 50 transfers the control frame from a predetermined MLAG port (for example, P[N] of FIG. 3), and the bridge frame control unit 52 in the frame processing unit 50 transfers the bridge control frame from the bridge port Pb to exit from the subroutine (step S204).

On the other hand, when the receiving port is not the MLAG port in the step S201, the receiving port is the bridge port Pb and the received frame is the bridge control frame. In this case, the frame processing unit 50 (specifically, bridge frame control unit 52) detects the control frame (for example, FL1[1] of FIG. 3) and the identifier of the receiving port (MLAG port) from the bridge control frame (for example, FL3 of FIG. 3) (step S205). Next, the frame processing unit 50 (specifically, snooping unit 53) learns the MC group contained in the detected control frame (IGMP report or the like) in association with its own MLAG port (for example, P[1] of FIG. 3) corresponding to the identifier of the detected port (MLAG port) on the MC address table 24 (step S206). Subsequently, the frame processing unit 50 discards the bridge control frame and exits from the subroutine (step S207).

In the retrieving subroutine for the MC address table in the step S105, the process shown in FIG. 12 is executed. In FIG. 12, the frame processing unit 50 first determines whether or not the receiving port is the MLAG port (step S301). When it is the MLAG port, the processing unit 50 (specifically, snooping unit 53) retrieves the MC address table 24 to determine the destination MLAG port of the MC user frame (step S302).

Next, the frame processing unit 50 determines whether or not the destination MLAG port has a fault with reference to, for example, the MLAG table 56 of FIG. 9A (step S303). When it has a fault (for example, in the case of P[1] of FIG. 5), the frame processing unit 50 transfers the MC user frame from the bridge port Pb and exits from the subroutine (step S304). Meanwhile, when it has no fault, the frame processing unit 50 transfers the MC user frame from the destination MLAG port and exits from the subroutine (step S306).

On the other hand, when the receiving port is not the MLAG port in the step S301, the receiving port is the bridge port Pb and the received frame is the MC user frame. In this case, the frame processing unit 50 (specifically, snooping unit 53) retrieves the MC address table 24 to determine the destination MLAG port of the MC user frame (step S305). Next, the frame processing unit 50 transfers the MC user frame from the destination MLAG port and exits from the subroutine (step S306).

In the foregoing, the invention made by the inventors of the present invention has been concretely described based on the embodiments. However, it is needless to say that the present invention is not limited to the foregoing embodiments and various modifications and alterations can be made within the scope of the present invention. For example, the embodiments above have been described in detail so as to make the present invention easily understood, and the present invention is not limited to the embodiment having all of the described constituent elements. Also, a part of the configuration of one embodiment may be replaced with the configuration of another embodiment, and the configuration of one embodiment may be added to the configuration of another embodiment. Furthermore, another configuration may be added to a part of the configuration of each embodiment, and a part of the configuration of each embodiment may be eliminated or replaced with another configuration.

What is claimed is:

1. A network relay system, comprising:
first and second switching devices each having a plurality of MLAG ports, a bridge port and a multicast address table and connected to each other by a bridge communication line through the bridge ports,
wherein each of the first and second switching devices sets a link aggregation group between its own MLAG port and a MLAG port of the other switching device corresponding to the MLAG port,
when one of the first and second switching devices receives a control frame representing a join request to or a leave request from a predetermined multicast group at any one of the plurality of MLAG ports, it executes a first process of learning the predetermined multicast group contained in the control frame in association with a MLAG port which has received the control frame on the multicast address table and a second process of generating a bridge control frame containing the control frame and an identifier of the MLAG port which has received the control frame and transferring the bridge control frame from the bridge port, and
when the other of the first and second switching devices receives the bridge control frame at the bridge port, it executes a third process of detecting the control frame and the identifier of the MLAG port from the bridge control frame and a fourth process of learning the predetermined multicast group contained in the control frame in association with its own MLAG port corresponding to the identifier of the MLAG port on the multicast address table.

2. The network relay system according to claim 1,
wherein, when one of the first and second switching devices receives a multicast user frame at any one of the plurality of MLAG ports, it further executes a fifth process of retrieving a destination MLAG port from among the plurality of MLAG ports based on the multicast address table and a sixth process of transferring the multicast user frame from the bridge port when the destination MLAG port has a fault, and
when the other of the first and second switching devices receives the multicast user frame at the bridge port, it executes a seventh process of retrieving a destination MLAG port from among the plurality of MLAG ports based on the multicast address table.

3. The network relay system according to claim 2,
wherein the second and third processes are executed by a dedicated hardware circuit.

4. A switching device, comprising: a plurality of MLAG ports; a bridge port; and a multicast address table, the bridge port being connected to a bridge port of another switching device, the switching device setting a link aggregation group between its own MLAG port and a MLAG port of the other switching device corresponding to the MLAG port,
wherein, when the switching device receives a control frame representing a join request to or a leave request from a predetermined multicast group at any one of the plurality of MLAG ports, it executes a first process of learning the predetermined multicast group contained in the control frame in association with a MLAG port which has received the control frame on the multicast address table and a second process of generating a bridge control frame containing the control frame and an identifier of the MLAG port which has received the control frame and transferring the bridge control frame from the bridge port, and
when the switching device receives the bridge control frame at the bridge port, it executes a third process of detecting the control frame and the identifier of the MLAG port from the bridge control frame and a fourth process of learning the predetermined multicast group contained in the control frame in association with its own MLAG port corresponding to the identifier of the MLAG port on the multicast address table.

5. The switching device according to claim 4,
wherein, when the switching device receives a multicast user frame at any one of the plurality of MLAG ports, it further executes a fifth process of retrieving a destination MLAG port from among the plurality of MLAG ports based on the multicast address table and a sixth process of transferring the multicast user frame from the bridge port when the destination MLAG port has a fault, and
when the switching device receives the multicast user frame at the bridge port, it executes a seventh process of retrieving a destination MLAG port from among the plurality of MLAG ports based on the multicast address table.

6. The switching device according to claim 5,
wherein the second and third processes are executed by a dedicated hardware circuit.
